(19) United States
(12) Patent Application Publication
(10) Pub. No.: US 2012/0149418 A1
(43) Pub. Date: Jun. 14, 2012

(54) BANDWIDTH ALLOCATION

(76) Inventors: Björ Skubic, Hasselby (SE); Elmar Trojer, Taby (SE)

(21) Appl. No.: 13/391,541

(22) PCT Filed: Aug. 21, 2009
(86) PCT No.: PCT/EP09/60842

§ 371 Date: Feb. 21, 2012

(51) Int. Cl. H04W 72/04; H04B 7/00

(52) U.S. Cl. 455/509

(57) ABSTRACT

Bandwidth allocation apparatus for apportioning bandwidth resource to at least one communications network node, the apparatus comprising a processor assembly and a logic array, the processor assembly comprises a data processor and a memory, the data processor configured to execute instructions stored in the memory and the logic array comprising a plurality of logic circuits connected in such a manner so as to implement particular processing of data, and the logic array arranged to determine bandwidth demand for the at least one node, and the processor assembly configured to at least in part calculate how the bandwidth is to be apportioned.

### TECHNICAL FIELD

The present invention relates generally to bandwidth allocation for a communications network.

### BACKGROUND

A Passive Optical Network (PON) comprises an Optical Line Termination (OLT), which resides in a Central Office (CO) and further comprises user modems, called Optical Network Terminals (ONT) or network units, called Optical Network Units (ONU). The OLT services a number of ONU's or ONT's, typically connected in a tree arrangement via an Optical Distribution Network (ODN) using an optical power splitter, which resides close to the user premises. Since the physical medium, of one or more communication links, is shared, the ONU's are scheduled by the OLT to transmit in the upstream direction in a Time Division Multiple Access (TDMA) manner.

In order to achieve high upstream bandwidth utilization the upstream scheduling must provide Dynamic Bandwidth Allocation (DBA), which allows for bandwidth resource between lightly loaded and heavily loaded ONU's to be shared.

The Gigabit Passive Optical Networking (GPON) standard ITU-T G.984.x, introduces the concept of a Transmission Container (T-CONT). A T-CONT may be viewed as an upstream queue for a particular type of traffic (for example. video, voice and data). Each ONU typically holds several T-CONT's. The bandwidth assignment in the scheduling is done purely on a per T-CONT basis. Each T-CONT in the PON system is identified by a so-called Alloc-ID. The OLT grants bandwidth to ONT's via a bandwidth map (BWmap) which comprises control signals sent in a downstream direction.

A Service Layer Agreement (SLA) associates each Alloc-ID with respective bandwidth requirements to allow each Alloc-ID to be suitably serviced with bandwidth. The bandwidth requirements for one Alloc-ID are described in terms of multiple bandwidth allocation classes. Each class has an associated bandwidth value, and together the values provide a total bandwidth value for servicing each Alloc-ID. For example fixed bandwidth, assured bandwidth, non-assured bandwidth and best-effort bandwidth classes could be included in the SLA. Hence, a particular Alloc-ID can be configured to obtain a certain amount of fixed bandwidth, up to a certain amount of assured bandwidth, up to a certain amount of non-assured bandwidth and up to a certain amount of best-effort bandwidth.

In order to be able to assign bandwidth to the T-CONT's according to need, the OLT may either utilize traffic monitoring or a messaging mechanism that has been introduced in the GPON protocol where status reports (containing queue occupancy) are transmitted to the OLT upon request. The OLT must, in addition to assigning bandwidth according to need, also enforce bandwidth guarantees, bandwidth capping and prioritization policies regarding traffic from different T-CONT's. The OLT is required to continually re-calculate how bandwidth is shared since the extent of queued traffic in each T-CONT varies over time.

We have realised that existing DBA solutions suffer from a number of limitations. Performance can be limited either because of slow and inefficient algorithms resulting in poor bandwidth utilization or because algorithms are too simple to enforce the desired bandwidth policies resulting in inefficient usage of the PON. Furthermore, existing solutions are unflexible and difficult to program and update.

We have realised that performance problems arise from the OLT performing multiple tasks, each with different processing speed requirements.

The present invention seeks to provide an improved apparatus and method for bandwidth allocation.

### SUMMARY

According to one aspect of the invention there is provided bandwidth allocation apparatus for apportioning bandwidth resource to at least one communications network node. The apparatus comprises a processor assembly and a logic array. The processor assembly comprises a data processor and a memory, the data processor configured to execute instructions stored in the memory. The logic array comprises a plurality of logic circuits connected in such a manner so as to implement particular processing of data. The logic array is arranged to determine bandwidth demand for the at least one node, and the processor assembly is configured to at least in part calculate how the bandwidth is to be apportioned.

Advantageously, processing of different bandwidth allocation tasks by particular processing entities significantly improves response times and flexibility.

Preferably the processor assembly is arranged to calculate bandwidth bounds of different bandwidth allocation classes in calculating how the bandwidth is to be apportioned.

Preferably the processor assembly is arranged to calculate prioritization weights in calculating how the bandwidth is to be apportioned.

Preferably the processor assembly is configured to calculate prioritization weights per bandwidth allocation class.

Preferably the processor assembly and the logic array are configured to implement respective sub-tasks in production of bandwidth allocation control signals to be sent to the at least one node.

Preferably the bandwidth allocation signals are indicative of timeslots for grant of bandwidth use.

Preferably the logic array is configured to output the bandwidth allocation control signals to be sent to the at least one node.

Preferably the processor is arranged to determine input parameters used to determine bandwidth apportionment.

Preferably the logic array is configured to receive the input parameters from the processor assembly and to use the input parameters to determine apportionment of bandwidth.

Preferably the processor assembly comprises a plurality of data processors. Preferably the data processors are substantially independently operative of one another and are hosted on a shared hardware platform.

Preferably the logic array is partitioned such that respective groups of logic circuits are provided for each data processor.

Preferably the apparatus is configured to allocate bandwidth in bandwidth allocation class order, and the apparatus configured to allocate bandwidth for a lower order class if it is determined that available bandwidth remains after bandwidth has been allocated to a higher order class, and the apparatus configured to determine to terminate bandwidth allocation if it is determined that no bandwidth remains after allocation to a class.

According to another aspect of the invention there is provided method of apportioning bandwidth resource to at least one communications network node, the method comprising a logic array determining bandwidth demand for the at least one node, and the method further comprising a processor assembly calculating, at least in part, how bandwidth is to be apportioned, the logic array comprising a plurality of logic circuits and the processor assembly comprising a data processor and a memory, the data processor configured to execute instructions stored in the memory.

### BRIEF DESCRIPTION OF THE DRAWINGS

Various embodiments of the invention will now be described, by way of example only, with reference to the accompanying drawings in which:

FIG. 1 shows a communications network,

FIG. 2 shows bandwidth allocation apparatus,

FIG. 3 shows a variant embodiment of the bandwidth allocation apparatus of FIG. 2,

FIG. 4 shows a flow diagram,

FIG. 5 shows a flow diagram,

FIG. 6 shows a flow diagram,

FIG. 7 shows a table, and

FIG. 8 shows a table.

### DETAILED DESCRIPTION

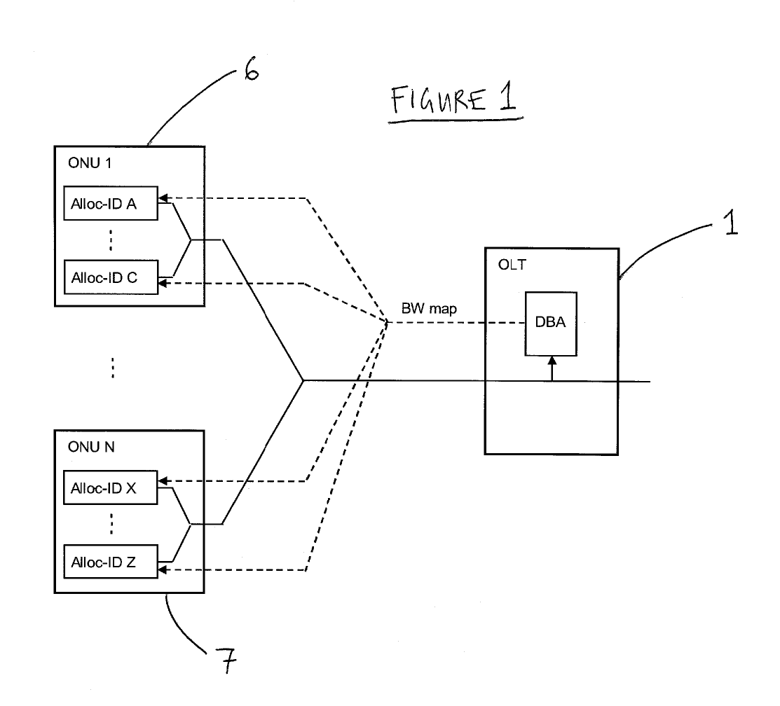

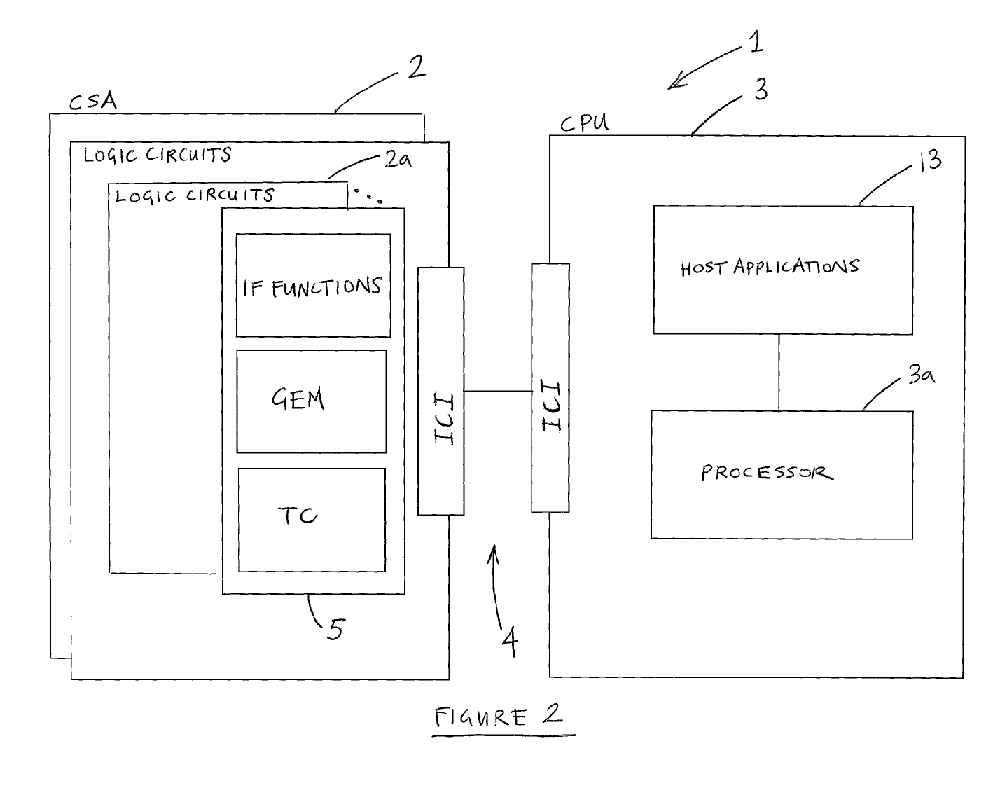

FIG. 1 shows a communications network node comprising an Optical Line Termination (OLT) 1 connected to two further network nodes, namely Optical Network Units (ONU) 6 and 7. The OLT 1 is arranged to implement Dynamic Bandwidth Allocation (DBA) for the ONU's 6 and 7 by way of a dual hardware architecture platform comprising a Configurable Switch Array (CSA) 2 and a Central Processing Unit (CPU) 3 which are connected by an inter-chip communication interface 4 as shown in FIG. 2. As is described in detail below, the DBA is optimized by the placement of respective DBA tasks on the CSA 2 and the CPU 3. The three principle DBA tasks are: (i) bandwidth demand prediction, (ii) bandwidth sharing and (iii) grant scheduling. Bandwidth demand prediction involves monitoring the amount of queued traffic at each ONU. Bandwidth sharing involves calculating how the available bandwidth is divided over the various queues of traffic at each ONU. Each queue at a ONU is called a T-CONT, identified by a respective Alloc-ID, and relates to a particular type of traffic (for example. video, voice and data). Each ONU typically holds several T-CONT's. The bandwidth assignment in the scheduling algorithm is done purely on a per T-CONT basis. Each T-CONT is specified by a T-CONT descriptor which contains criteria relating to maximum permissible bandwidth to be assigned to the T-CONT as well as the proportions as to how the granted bandwidth is to be shared over the different bandwidth allocation classes for each T-CONT, such as fixed bandwidth, assured bandwidth, non-assured bandwidth, best-effort bandwidth. Within the Gigabit Passive Optical Networking (GPON) standard upstream transmission is based on the standard 125 μs periodicity. The DBA process produces an upstream bandwidth map comprising a control signal, or sequence of control signals, sent to the ONU's which divides the bandwidth of a 125 μs super frame between the ONU's. The DBA process is executed with regular intervals at the OLT 1 producing an updated bandwidth map or sequence of bandwidth maps that can be used once or iteratively until it is updated.

The CSA 2 comprises a configurable logic array made up of a plurality of logic circuits 2a connected in such a manner so as to implement particular processing of data. The logic circuits may be implemented as either a Field Programmable Gate Array (FPGA) or Application Specific Integrated Circuit (ASIC).

The CSA 2 also comprises various functional entities, shown generally at 5, to process internal signals to and from the CSA and the CPU, and external signals to and from the node 1. The functional entities, which may be viewed as a MAC implementation on logic circuits, include interface functions (shown as IF functions), traffic management function G-PON Encapsulation Method (shown as GEM) and a transmission convergence layer (shown as TC). Although not specifically referred to in FIG. 2 the functional entities also include network interfaces (LOGE interfaces) including XAUI SERDES, 10GE MAC blocks and elasticity First In First Out (FIFO) structures, followed by different protocol specific encapsulation engines including traffic management facilities such as G.984.3 GEM. The transmission convergence layer, indicated by GPON TC, includes header and frame generation together with forward error correction Reed-Solomon encoders and AES encryption. All these features of the CSA 2 run at very high clock-frequencies (for example in the range 400 MHz up to 2 GHz) to achieve bi-directional rates of 40 Gbit/s. The CSA 2 supports special hardware accelerators to support these high-demand packet processing features based on logic operators. The CPU 3 is arranged to perform lower speed functions that require high floating-point arithmetic performance such as dynamic bandwidth management together with common control plane functions such as Operations Administration and Maintenance (OAM) and ONT management. The CPU comprises a multi-core central processor unit 3a. The CPU 3 is provided with host applications in a memory 13 which provide instructions for execution by the processor unit 3a.

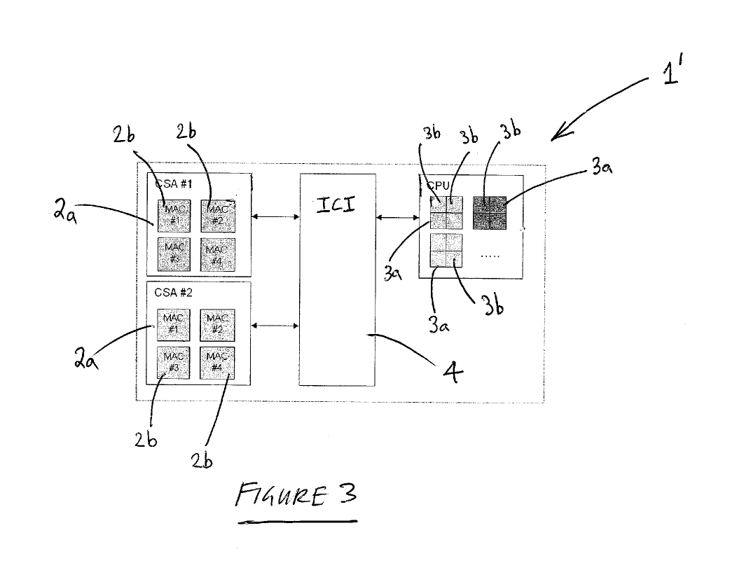

With reference to FIG. 3 there is shown a variant embodiment 1′ in which the CPU comprises a plurality of multi-core processors 3a and a plurality of CSA's 2a. Each multi-core processor 3a comprises a plurality of processor cores 3b. The multi-core processors 3a all reside on a common, or shared, hardware platform but are capable of operating substantially independently of one another. Each CSA 2a comprises a field programmable gate array (or similar), and the numerous gates (which constitute the logic circuits) are partitioned so as to form respective groups of gates which each provide a logic array 2b for a respective processor core 3b. Each logic array is referenced by way of a particular GPON Media Access Control (MAC). An inter-chip-interface (ICI) 4, comprising a switch, is provided to allow the CSA's 2a to communicate with the processor cores 3a. The ICI 4 is arranged to permit point-to-multipoint signalling. Thus, in this embodiment, the CPU is a common and shared resource for the OLT 1 which provides several advantages over a concentrated architecture, including:

Shared costs: The cost per port is given by the cost of the MAC in the CSA plus the cost of the CPU resources needed for the PON system.

Since DBA is central in an OLT, smart uplink load balancing is possible.

OAM and OMCI are performed centrally which allows simplification of the control plane and easy support of new features such as protection switching and seamless system upgrade.

As implemented by the OLT 1, the DBA process can be considered as being split into separate units of functionality comprising: (A) prediction of bandwidth demand (including DBA message handling), (B) calculation of temporal bandwidth bounds, (C) calculation of prioritization weights, (D) the assignment of bandwidth and (E) the scheduling of bandwidth grants. Units B, C and D can be said to together constitute the bandwidth sharing task. Interfaces are defined between units A-C and D as well as D and E. Four variables are introduced: bandwidth demand per queue (B_{dem,i}), temporary maximum bandwidth per queue and bandwidth allocation class (B_{max,i,j}), temporary weight per queue and bandwidth allocation class (W_{i,j}) and bandwidth grant per queue up to a certain bandwidth allocation class (M_{i,j}).

Two embodiments of distributing the DBA functionality are described below. These are referred to as DBA 1 and DBA 2

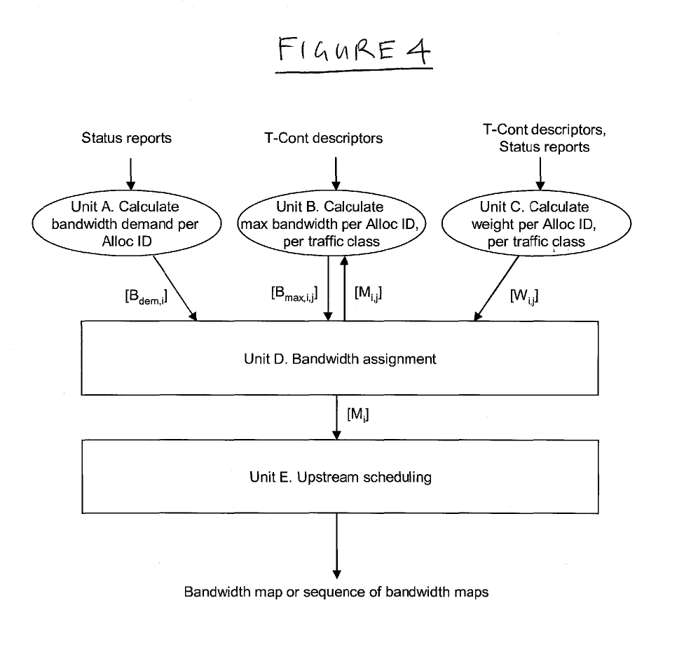

With reference to FIG. 4, the implementation of DBA 1 comprises placing functionality A on the CSA 2 close to a downstream interface in a processing architecture which runs on a high clock speed synchronised with the downstream interface. Functionalities B and C are located on the CPU 3 close to a management interface. Functionality D is placed on the CPU 3 in an architecture with sufficient processing power and high floating-point arithmetic capabilities. Functionality E is partially placed on the CPU for the calculation of more complex scheduling features, whereas a simple Physical Layer OAM downstream (PLOAMd) builder is located on the CSA constructing the actual PLOAMd message for the downstream GTC header. This partitioning provides a conceptually satisfying way of splitting up the different DBA tasks onto the partitioned hardware architecture. In DBA 1 it will be appreciated that a large proportion of the DBA activities are located on the CPU 3.

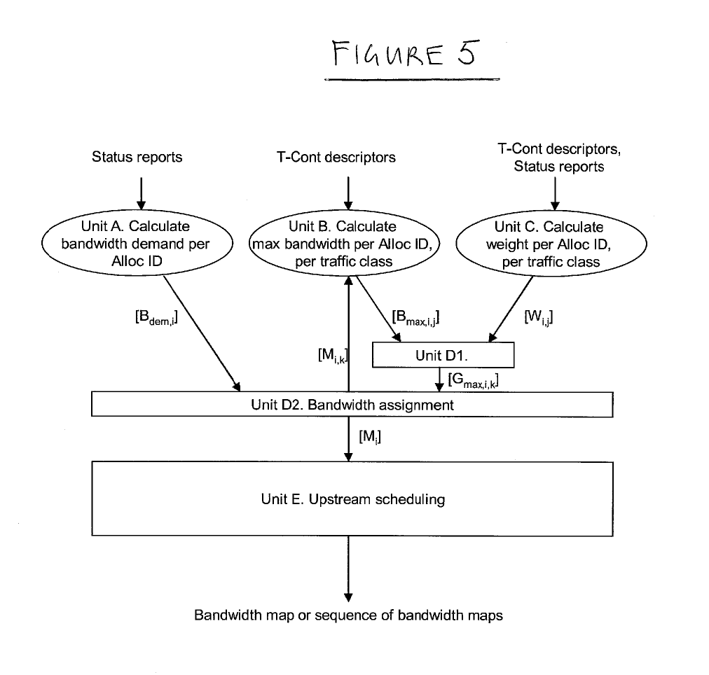

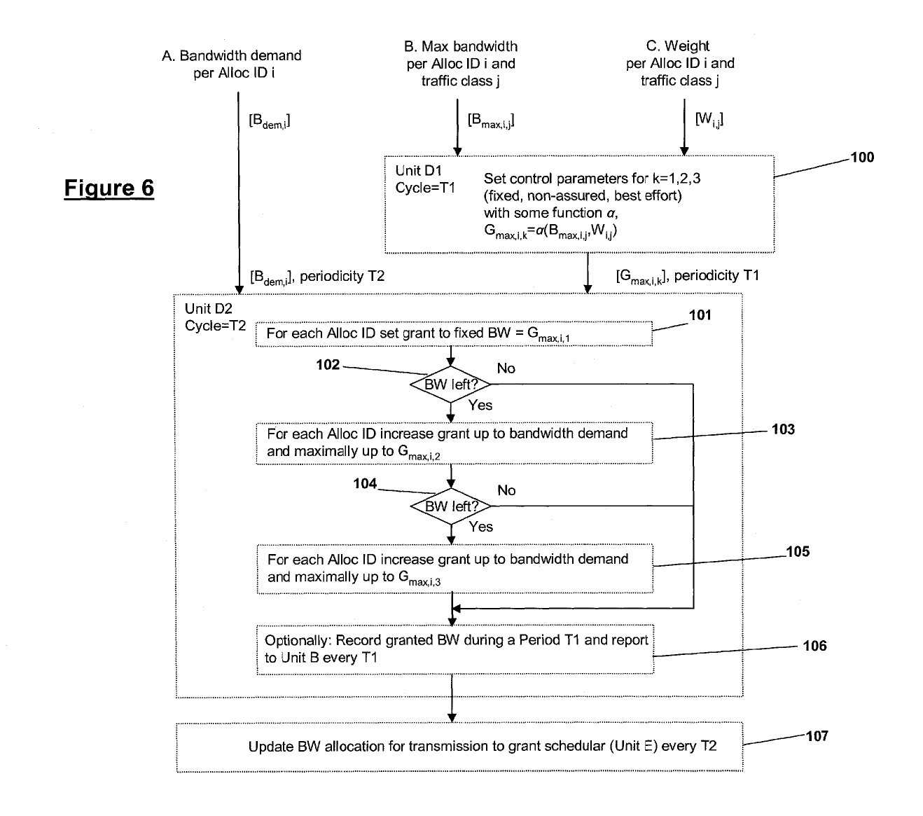

DBA 2 is now described with reference to FIGS. 5 and 6. DBA 2 is identical to DBA 1 save that functionality D, which manages the bandwidth assignment, has been partitioned into two parts. A computationally straightforward part (D2) which produces a bandwidth map based on bandwidth demand and input parameters (G_{max,i,k}). The other part (D1) comprises a computationally complex part which manages the bandwidth sharing and constructs the input parameters for algorithm (D2). Functionalities A, D2 and E are placed on the CSA 2. Units B, C and D1 are placed on the CPU 3. An important advantage of the DBA 2 arrangement is that the bandwidth map produced at D2, which is based on bandwidth demand, can be updated with a higher frequency than the input parameters. The complex bandwidth sharing algorithm can be executed with a lower frequency providing fair bandwidth sharing on a larger time scale. DBA 2 benefits from producing a fast response to traffic load while still maintaining complex Quality of Service (QoS) assurance and priorities.

FIG. 6 shows a possible implementation of how the functional steps could be distributed over D1 and D2. It will be appreciated that reference to BW in FIG. 6 refers to bandwidth. It is also to be noted that three bandwidth allocation classes of traffic are considered, namely fixed, non-assured and best effort (in order of priority). At step 100, the control parameters are determined by the unit D2. At step 101, unit D2 the fixed bandwidth is set for each Alloc-ID. At step 102, if any bandwidth remains, D2 allocates, at step 103, to the next class (i.e. non-assured) of each Alloc-ID bandwidth equal to determined demand. If at step 105 it is determined that there is surplus bandwidth, then allocation for the next class, non-assured, bandwidth allocation is increased up to demand for each Alloc-ID. At step 106, an optional step of recording the bandwidth granted and then reporting this to unit B. At step 107, the bandwidth allocation data is updated for transmission to the grant scheduler in Unit E. It is to be noted that if at any of steps 102 and 104, it is determined that there is insufficient bandwidth remaining for any of the lower classes then either step 106 or step 107 is proceeded to.

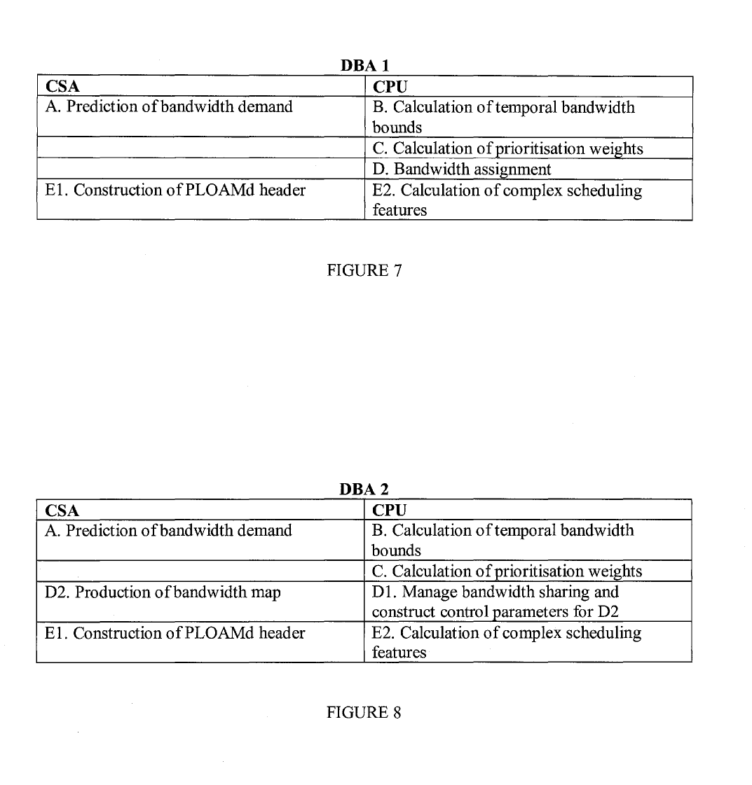

FIGS. 7 and 8 provide tabulated summaries of the respective functionalities implemented by each of the CSA 2 and the CPU 3 for each of DBA 1 and DBA 2. It is to be noted that the split in the functionality of scheduling of bandwidth grants referred to above is shown as part E1 and part E2. It is to be noted that D1 runs on a cycle T1 and D2 runs on a cycle T2 (≦T1).

Both of the above embodiments of the DBA 1 and DBA 2 arrangements take account of different tasks requiring different processing requirements. For example, the management of status report requires high speed processing with low delays and synchronization with the downstream interface and so is advantageously located on the CSA 2. On the other hand, bandwidth sharing tasks require high floating-point arithmetic capabilities but are less timing sensitive and so are conveniently located on the CPU 2. Significantly improved performance results from the architectures of relating to DBA 1 and DBA 2. Programming and upgrading flexibility is provided by the CPU structure. Arithmetic-heavy functions such as the computation of statistics and heuristics are cumbersome to implement, test, and maintain on logic circuits. On CPUs such functions can be more easily developed and tested.

1. Bandwidth allocation apparatus for apportioning bandwidth resource to at least one communications network node, the apparatus comprising
a processor assembly comprising a data processor and a memory, the data processor for executing instructions stored in the memory and
a logic array comprising a plurality of logic circuits connected so as to implement particular processing of data, and to determine bandwidth demand for the at least one communications network node, and the processor assembly configured to, at least in part, calculate how the bandwidth is to be apportioned.

2. The apparatus as claimed in claim 1, the processor assembly arranged to calculate bandwidth bounds of different bandwidth allocation classes in calculating how the bandwidth is to be apportioned.

3. The apparatus as claimed in claim 2, the processor assembly arranged to calculate maximum allowed bandwidth per bandwidth allocation class.

4. The apparatus as claimed in claim 1, the processor assembly arranged to calculate prioritization weights in calculating how the bandwidth is be apportioned.

5. The apparatus as claimed in claim 4, the processor assembly being configured to calculate prioritization weights per bandwidth allocation class.

6. The apparatus as claimed in claim 1 in which the processor assembly and the logic array are configured to implement respective sub-tasks in production of bandwidth allocation control signals to be sent to the at least one communications network node.

7. The apparatus as claimed in claim 6 in which the bandwidth allocation signals are indicative of timeslots for grant of bandwidth use.

8. The apparatus as claimed in claim 7, the logic array configured to output the bandwidth allocation control signals to be sent to the at least communications network one node.

9. The apparatus as claimed in claim 1 the processor assembly being arranged to determine input parameters used to determine bandwidth apportionment.

10. The apparatus as claimed in claim 9, the logic array configured to receive the input parameters from the processor assembly and to use the input parameters to determine apportionment of bandwidth.

11. The apparatus as claimed in claim 1 in which the processor assembly comprises a plurality of data processors.

12. The apparatus as claimed in claim 11, the data processors independently operative of one another and hosted on a shared hardware platform.

13. The apparatus as claimed in claim 11, the logic array partitioned such that respective groups of logic circuits are provided for each data processor.

14. The apparatus as claimed in claim 1 allocating bandwidth:
in bandwidth allocation class order,
for a lower order class if it is determined that available bandwidth remains after bandwidth has been allocated to a higher order class, and
terminating bandwidth allocation if it is determined that no bandwidth remains after allocation to a class.

15. A method of apportioning bandwidth resource to at least one communications network node, the method comprising
a logic array comprising a plurality of logic circuits for determining bandwidth demand for the at least one communications network node, and
a processor assembly calculating, at least in part, how bandwidth is to be apportioned, and the processor assembly comprising a data processor and a memory, the data processor configured to execute instructions stored in the memory.
